(19) United States
(12) Patent Application Publication
(10) Pub. No.: US 2010/0309138 A1
(43) Pub. Date: Dec. 9, 2010

(54) Position detection apparatus and method thereof

(76) Inventor: Ching-Feng Lee, Fongyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,223

(22) Filed: Jun. 4, 2009

(51) Int. Cl. G06F 3/041

(52) U.S. Cl. 345/173

(57) ABSTRACT

A position detection apparatus is provided, which includes a frame, a plurality of image capturing units, and a processing unit. The frame surrounds an area. The image capturing units are individually set within the frame, and each image capturing unit captures a positional image of the area. The processing unit is coupled with the image capturing units. If there is an object situated at a particular position within the area, the processing unit will determine the particular position of the object according to each of the positional image.

### BACKGROUND OF THE INVENTION

1. Field of the Invention

The present invention relates to a detection apparatus, in particular, to a position detection apparatus and a method thereof.

2. Description of Related Art

In recent years, touch panels have been used extensively in areas such as personal digital assistant (PDA), tour guide system, automatic teller machine (ATM), and point of sale (POS) terminal, etc. At present, touch panels are divided into resistance touch panels, capacitive touch panels, and infrared touch panels according to the type of technology.

For a capacitive touch panel, conducting materials such as antimony tin oxide (ATO) film and silver paste or wires are coated onto a piece of glass sheet, and an anti-scratch protective film is coated onto an external side of the touch panel. Electrodes are disposed around the glass sheet to produce a uniform low-voltage electric field at an external conductive layer. An internal conductive layer provides an electromagnetic shield for reducing or eliminating noises. If a finger touches a screen, the finger together with the electric field at the external conductive layer will produce a capacitance coupling for drawing tiny currents. Each electrode is provided for measuring the magnitude of currents coming from each corner of the screen so as to define the coordinates of the finger. The capacitive touch panel has the advantages of high stability, excellent transmittance, and strong surface hardness, along with the disadvantages of high price and complicated manufacturing process.

As to the resistance touch panel, the resistance touch panel is formed by an indium tin oxide (ITO) film, a piece of ITO glass, and a layer of tiny separation dots made of polyester conductive glass and disposed between the conductive ITO glass and the conductive ITO film. A controller is disposed individually along the X-axis of the ITO glass and the Y-axis of the conductive film for imposing a small voltage gradient. If a finger touches a panel, the conductive layers will be pressed together, such that X coordinate and Y coordinate of a touch point will be detected. The resistance touch panel has the advantages of a lower manufacturing cost and a simpler structure, along with the disadvantages of a lower transmittance and a weaker surface hardness than the capacitive touch panel.

The infrared touch panel adopts the light source interruption principle and installs infrared transmitters and receivers around a display screen, such that if an object touches the screen, the light signal will be interrupted, and coordinates of the point on the screen touched by the object can be determined according to signals received by the receivers. A “position detection apparatus” as disclosed in R.O.C. Pat. Publication No. 200805123 detects a particular position by using infrared. With reference to FIG. 1 for a schematic perspective view of a conventional position detection apparatus, the position detection apparatus 1 comprises a frame 11, a plurality of infrared light sources 131, 133, 135, 137, and a plurality of light receivers 132, 134, 136, 138. The infrared light sources 131, 133, 135, 137 and the light receivers 132, 134, 136, 138 are installed on the frame 11, and the light receivers 132, 134, 136, 138 are provided for receiving lights emitted by the infrared light sources 131, 133, 135, 137.

The position detection apparatus 1 is used together with a screen 111 and a frame 11 installed around the screen 111. If a finger or any other object is placed at a particular position within the region surrounded by the frame 11 to block and interrupt the infrared light, then some of the light receivers 132, 134, 136, 138 will be unable to receive the lights emitted from the infrared light sources 131, 133, 135, 137. Therefore the X coordinate and Y coordinate of the object in the frame 11 can be determined by the positions of the light receivers 132, 134, 136, 138 having a light interruption.

More specifically, if an object 15 is placed at a particular position within the region surrounded by the frame 11, the object 15 will block light signals transmitted from the infrared light sources 131, 133, 135, 137, such that the intensity of light signals received by some light receivers 132, 134, 136, 138 is decreased. With the analysis of the intensity of the light signal received by each of the light receivers 132, 134, 136, 138 through a processor (not shown in the figure), the position of the object 15 placed within the region surrounded by the frame 11 can be determined according to a change of intensity of the light signal received by each of the light receivers 132, 134, 136, 138. In FIG. 1, the position of the object 15 placed within the region surrounded by the frame 11 can be determined by four intersections of connected lines formed between the light receivers 132, 134, 136, 138 and each infrared light source 131, 133, 135, 137.

### SUMMARY OF THE INVENTION

To achieve the above-mentioned objectives, the present invention provides a position detection apparatus and a position detection method that captures a plurality of side-view images of the screen surface from different angles around the periphery of the screen and analyzes the change of each image to aggregately compute the position of an object touching or striking the screen to timely detect the touched position on the touch screen.

The present invention discloses a position detection apparatus comprising a frame, a plurality of image capturing units and a processing unit. The frame encloses and defines a planar area. The image capturing units are installed on the frame, and each image capturing unit is used for capturing a positional side-view image of the enclosed area. The processing unit is coupled to the image capturing units, such that if an object approaches or touches a particular position in the area, the processing unit will be able to determine the particular position touched by the object according to the plurality of captured positional images.

The present invention discloses a position detection method for determining the particular position of at least one object situated on a planar object. The position detection method comprises the steps of: installing a plurality of image capturing units around the periphery of the planar object; with each image capturing unit capturing a positional image of the object situated on the planar object, wherein the positional image records a correspondence relationship between the particular position of the object and a surface position on the planar object; and determining the particular position of the object according to each positional image.

With the aforementioned technical solution, the present invention installs a plurality of image sensors around the periphery of the screen, and uses the sensors to detect a change of the side-view image of the screen surface to estimate the actual position of the touched point on the screen, so as to timely and accurately detect the coordinates of the touched point on the screen.

In order to further understand the techniques, means, and effects the present invention takes to achieve the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic perspective view of a conventional position detection apparatus;

FIG. 2 is a schematic perspective view of a position detection apparatus in accordance with a preferred embodiment of the present invention;

FIG. 3 is a schematic view of a system structure of the position detection apparatus in accordance with a preferred embodiment of the present invention;

FIG. 4 is a schematic view of operating a position detection apparatus in accordance with a preferred embodiment of the present invention;

FIG. 5 is a schematic view of a positional image in accordance with a preferred embodiment of the present invention;

FIG. 6 is a schematic view of a sample point in accordance with a preferred embodiment of the present invention;

FIG. 7 is a schematic view of a correspondence table in accordance with a preferred embodiment of the present invention; and

FIG. 8 is a flow chart of a position detection method in accordance with a preferred embodiment of the present invention.

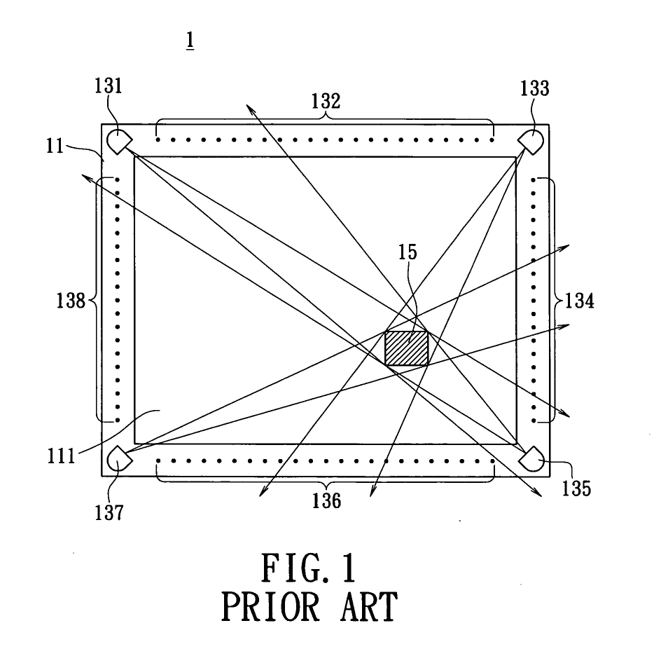

### DETAILED DESCRIPTION OF THE PREFERRED EMBODIMENTS

The present invention discloses a position detection apparatus and a position detection method that establish as factory default settings a correspondence relationship between a surface position of a screen and each of the periphery image capturing units, such that if any object touches the screen, each image capturing unit will detect a change in the side-view image of the screen surface, and the correspondence relationship is used for analyzing the change of each image to estimate the actual position of the object touching the screen surface.

The present invention is technically characterized by image capturing devices installed around the periphery of the screen, and by detecting a change in the side-view image of the screen surface to determine position coordinates of the touched point on the screen surface. The following descriptions of an internal system structure and its flow chart are given for the purpose of illustrating the present invention, but the invention is not limited to these preferred embodiments only, and the persons ordinarily skilled in the art can use equivalent components, display screen, and electronic devices for the present invention.

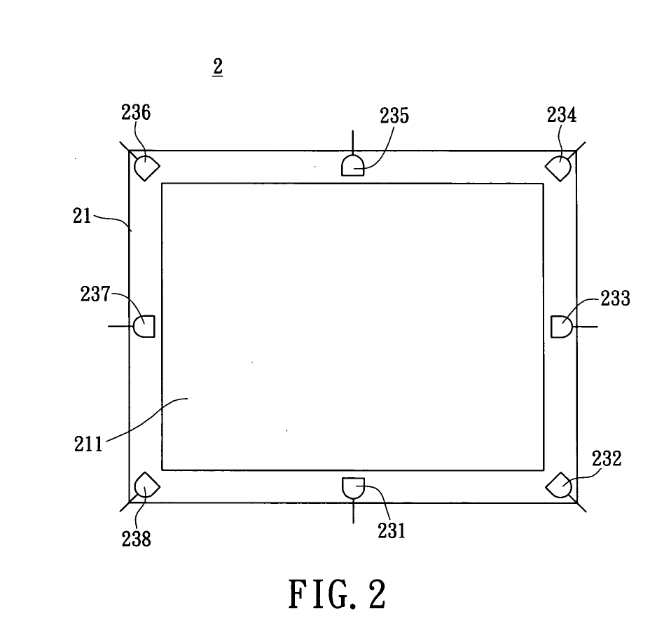

With reference to FIG. 2 for a schematic perspective view of a position detection apparatus in accordance with a preferred embodiment of the present invention, the position detection apparatus 2 comprises a frame 21 and a plurality of image capturing units 231˜238. An area 211 is enclosed and defined by the frame 2, and the image capturing units 231˜238 are disposed on the frame 21 for capturing side-view images within the area 211. More specifically, the image capturing units 231˜238 are directed precisely towards the center of the area 211 and disposed evenly on the frame 21. The image capturing units 231˜238 are complementary metal oxide semiconductor (CMOS) sensors, digital cameras, or a combination of the two.

It is noteworthy to point out that the quantity of image capturing units adopted in this preferred embodiment is equal to eight, but the quantity is not limited to such arrangement only.

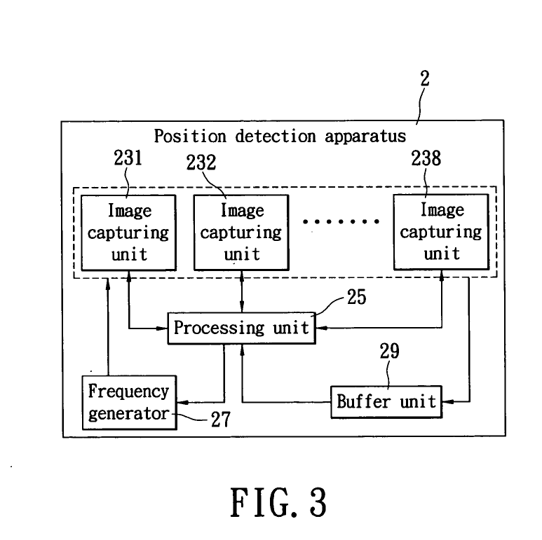

With reference to FIG. 3 for a schematic view of a system structure of a position detection apparatus in accordance with a preferred embodiment of the present invention, the position detection apparatus 2 further comprises a processing unit 25, a frequency generator 27, and a buffer unit 29. The processing unit 25 is coupled to the image capturing units 231˜238 for processing captured images; and the frequency generator 27 is coupled to the image capturing units 231˜238 for controlling the image capturing units 231˜238 to capture images periodically within a specific cycle; and the buffer unit 29 is provided for storing the captured images.

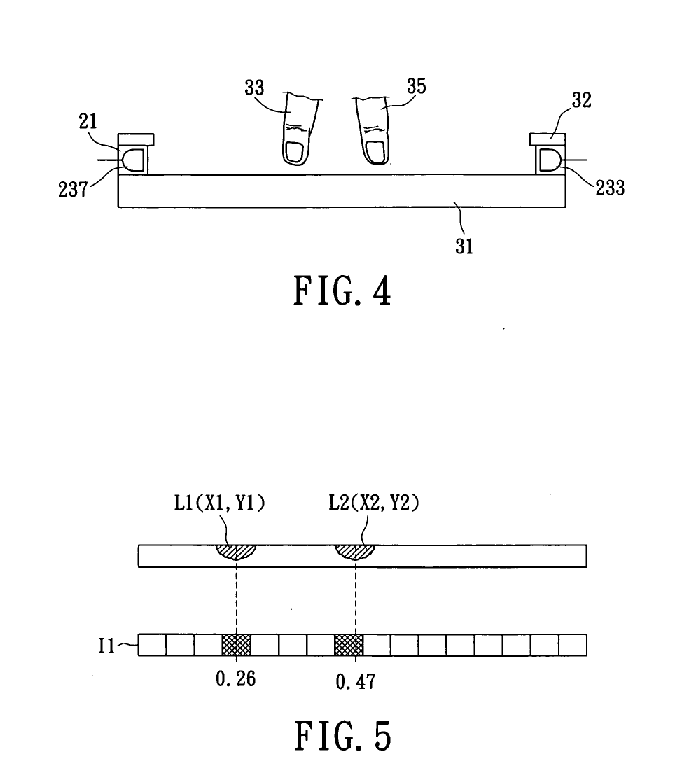

With reference to FIG. 4 for a schematic view of a position detection apparatus in accordance with a preferred embodiment of the present invention, the operating modes of the present invention are illustrated here. In FIG. 4, a frame 21 of a position detection apparatus 2 is used together with a planar object 31, and the frame 21 is installed around the planar object 31 for defining an area 211 on the planar object 31. More specifically, the planar object 31 is a display screen of a computer system, such that if a user touches (or approaches) a particular position in the area 211 on the planar object 31 with an object 33, 35, the image capturing units 231˜238 will detect changes in the side-view images of the area 211 and therefore will initiate capturing of positional images in directions pointing towards the object 33, 35, wherein each positional image containing the correspondence relationships between the particular position of the object 33, 35 and a surface position of the planar object 31; and finally, the processing unit 25 computes an actual particular position of the object 33, 35 according to the positional image captured by each image capturing unit. More specifically, the object 33, 35 can be either a user's fingers or a pen.

In a preferred embodiment of the present invention, the position detection apparatus 2 further comprises an optional eave-hood 32, wherein the frame 21 is installed between the planar object 31 and the optional eave-hood 32 for confining the scope of the area 211 detected by the image capturing units 231˜238 to avoid unnecessary initiation of capturing of positional images by the image capturing units 231˜238 when detecting a change of the images occurring outside the area 211.

With reference to FIG. 5 for a schematic view of a positional image in accordance with a preferred embodiment of the present invention, an object 33 is placed at a particular position L1 with coordinates equal to (X1, Y1), and an object 35 is placed at a particular position L2 with coordinates equal to (X2, Y2), and the side-view images of such two objects placed at particular positions L1, L2 as captured by each image capturing unit 231˜238 from different direction are different. The positional image I1 captured by the image capturing unit 231 contains the correspondence relationship between the positions of two objects 33, 35 and a surface position on the planar object 31, and the remaining image capturing units 232˜238 also capture a plurality of positional images I2˜I8 (not shown in the figure) from different directions, containing respective correspondence relationship between the positions of two objects 33, 35 and a surface position on the planar object 31. Therefore, a processing unit 25 can calculate the coordinates of two particular positions L1, L2 from the position information contained in the eight positional images I1˜I8.

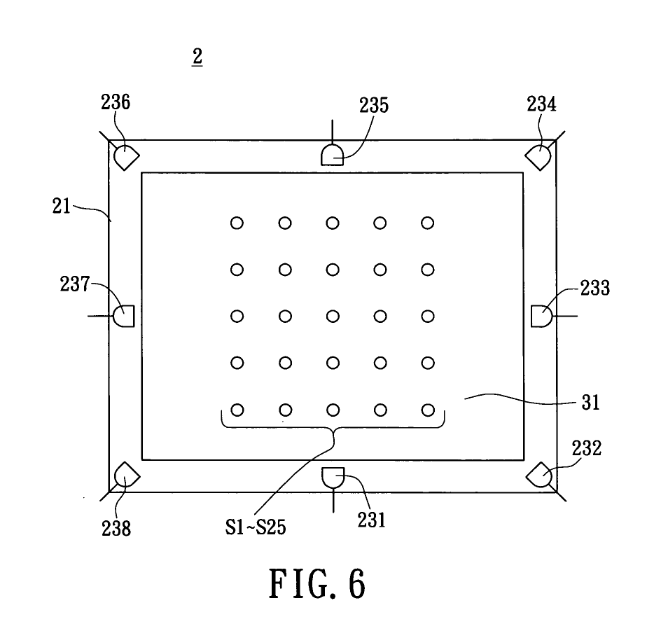

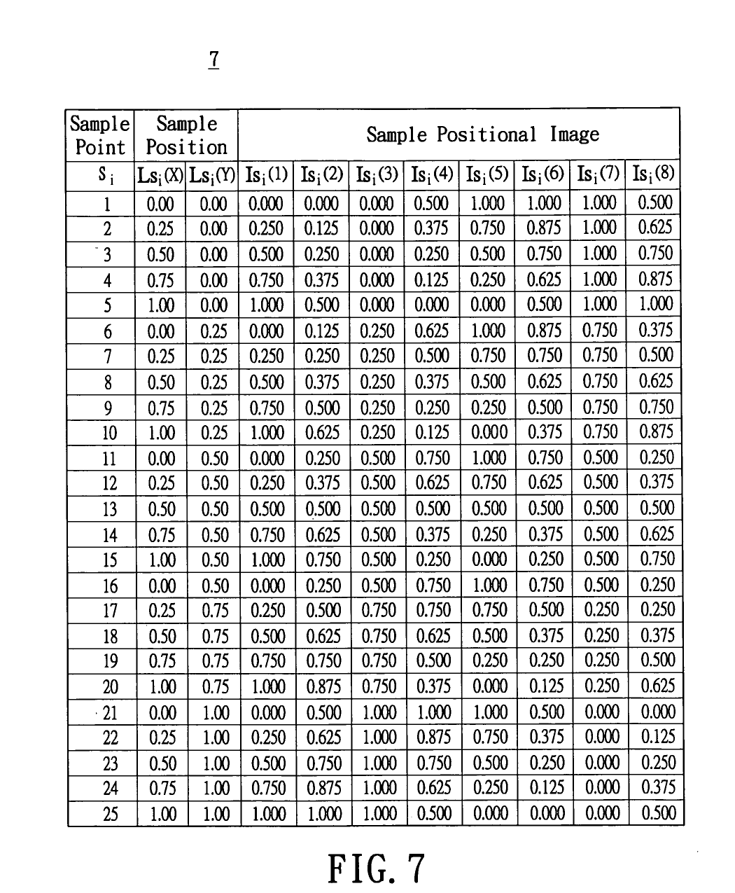

It is noteworthy to point out that, before being put into use, the position detection apparatus 2 must have established a correspondence relationship between a surface position on the planar object 31 and the image capturing units 231˜238 to calibrate the positional image in order to calculate the accurate particular position of the object. There are many ways of establishing the correspondence relationship. In a preferred embodiment as shown in FIG. 6, for each of a plurality of sample points S1˜S25 on the planar object 31 clicked, all image capturing units will each capture a sample positional image for the clicked sample point S1 to contain the correspondence relationship between the coordinates of the sample point S1 and its surface position on the planar object 31, and finally the processing unit 25 will use information related to the sample point S1 such as its sample position and its sample positional image to generate a table showing the correspondence relationship. In FIG. 7, a sample point S1 is used for the illustration, wherein the coordinates of the sample position are (0, 0), and each image capturing unit 231˜238 sees a sample positional image with relative position represented by (0, 0, 0, 0.5, 1, 1, 1, 0.5), and so on.

In the correspondence table 7 as shown in FIG. 7, the position of the object 33, 35 on the planar object 31 can be calculated. The position of the object 33 is L1 [0.32, 0.78], and the position of the object 35 is L2 [0.86, 0.19], and the numerical values converted from the positional images of the object 33 captured by the image capturing unit 231˜238 are V_{L1} [0.32, 0.55, 0.78, 0.73, 0.68, 0.45, 0.22, 0.27], and the processing unit 25 will compare V_{L1} with the numerical value I_{S1} converted from each sample positional image one by one to find out at least one sample point S1 closest to the object 33 (which is the sample point S17). The distance between the sample point S17 and the object 33 is calculated according to the sample positional image of the sample point S17 to calibrate V_{L1} as shown in Equation (1), and the calculated distance and sample position of the sample point S17 are used to determine the actual particular position L1 of the object 33 as shown in Equation (2). Similarly, the particular position L2 of the object 35 is calculated. Even if the user clicks a plurality of positions on the planar object 31, the processing unit 25 can still use the positional image captured by the image capturing unit and calibrate the correspondence table 7 to estimate the actual position of each object.

$$\begin{matrix}\begin{matrix}L 1 = Calibrate ( {V}_{L 1} , 17 , \{ {I}_{Si} \} ) \\ = [ \begin{matrix}{V}_{L 1} ( 1 ) - {I}_{S 17} ( 1 ) & {V}_{L 1} ( 3 ) - {I}_{S 17} ( 3 )\end{matrix} ] \\ = [ \begin{matrix}0.32 - 0.25 & 0.78 - 0.75\end{matrix} ] \\ = [ \begin{matrix}0.07 & 0.03\end{matrix} ]\end{matrix} & Equation ( 1 ) \\ \begin{matrix}L 1 = {L}_{S 17} + Δ L 1 \\ = [ \begin{matrix}0.25 + 0.07 & 0.75 + 0.03\end{matrix} ] \\ = [ \begin{matrix}0.32 & 0.78\end{matrix} ]\end{matrix} & Equation ( 2 )\end{matrix}$$

In a preferred embodiment of the present invention, positional images can be obtained by, in addition to the method of detecting a change of images on a planar object 31, using a frequency generator 27 for controlling the image capturing units 231˜238 to capture positional images from different directions periodically at a specific cycle. In this method, a buffer unit 29 will store positional images captured at current cycle and previous cycle, and the processing unit 25 compares in real time the positional images captured at the two time points and uses the difference to determine the particular position of the object.

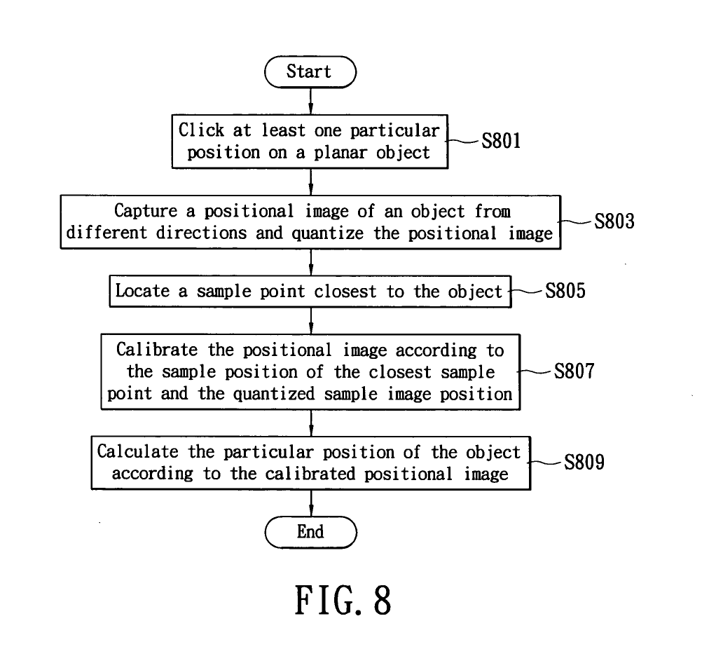

With reference to FIG. 8 for a flow chart of a position detection method in accordance with a preferred embodiment of the present invention, and FIGS. 2 to 7 for related system structure therein, the position detection method comprises the steps of:

Clicking particular positions L1, L2 on a planar object 31 by objects 33, 35 respectively (Step S801); capturing positional images of the objects 33, 35 by each image capturing unit 231˜238 from different directions, and quantifying the positional images according to a correspondence relationship and a proportion relationship between the particular positions L1, L2 and a surface position of the planar object 31 (Step S803);

The processing unit 25 comparing the quantified positional images with each numerical value I_{S1} converted from each sample positional image one by one to find out a sample point S1 closest to the object (Step S805); with the sample point Si found, the processing unit 25 looking up the sample position and the quantified sample positional image from the correspondence table 7, and calibrating the quantified positional image according to Equation (1) (Step S807); and

The processing unit 25 calculating a particular position L1, L2 of the object 33, 35 from the calibrated positional image according to Equation (1) (Step S809).

From the detailed description of the foregoing preferred embodiments, the position detection apparatus and the position detection method of the invention works by detecting an image on a screen from different angles, and analyzing a change of images to calculate position coordinates of an object touching the screen. The invention achieves the effects of lowering the cost of a circuit design for the traditional resistance touch panel or capacitive touch panel and reducing the error of detecting a position. In addition, through a plurality of image capturing units provided for detecting an image from different positions and directions, and through calibration of a correspondence table, the effect of detecting a plurality of touched positions can be achieved, so as to provide a more diversified control mode of the position detection apparatus.

The above-mentioned descriptions represent merely the preferred embodiment of the present invention, without any intention to limit the scope of the present invention thereto. Various equivalent changes, alternations, or modifications based on the claims of the present invention are all consequently viewed as being embraced by the scope of the present invention.

What is claimed is:

1. A position detection apparatus, comprising:
a frame, for enclosing and defining an area;
a plurality of image capturing units, individually installed on the frame, and each image capturing unit being used for capturing a positional image within the area; and
a processing unit, coupled to the image capturing units;
thereby, if at least one object is situated at a particular position in the area, then the processing unit determines the particular position of the object according to all captured positional images.

2. The position detection apparatus of claim 1, wherein the image capturing unit starts capturing the positional images, if there is an image change in the area.

3. The position detection apparatus of claim 1, further comprising:
a frequency generator, coupled to the image capturing unit, for controlling the image capturing unit to capture the positional image within a specific cycle; and
a buffer unit, for storing the most recently captured positional images.

4. The position detection apparatus of claim 3, wherein the buffer unit further stores a positional image captured in a previous cycle.

5. The position detection apparatus of claim 4, wherein the processing unit compares the most recently captured positional image with the positional image captured in the previous cycle, and determines the particular position of the object according to the difference of most recently captured positional image and the positional image captured in the previous cycle.

6. The position detection apparatus of claim 2, wherein the frame is disposed around a planar object and installed on the planar object for defining the area on the planar object.

7. The position detection apparatus of claim 6, wherein the planar object is a display screen.

8. The position detection apparatus of claim 6, wherein the frame is installed between the planar object and a shroud, and the shroud is provided for reducing the size of the area sensed by the image capturing unit.

9. The position detection apparatus of claim 1, wherein the image capturing unit is a complementary metal oxide semiconductor (CMOS) sensor, a digital camera, or a combination of the two.

10. A position detection method, for determining at least one object situated at a particular position on a planar object, and the method comprising the steps of:
installing a plurality of image capturing units at the periphery of the planar object;
capturing a positional image of the object by each of the image capturing units, wherein the positional image records a correspondence relationship between the particular position of the object and a surface position of the planar object; and
determining the particular position of the object according to each positional image.

11. The position detection method of claim 10, further comprising the steps of:
establishing a correspondence relationship between a surface position of the planar object and the image capturing unit; and
calibrating the positional image according to the correspondence relationship.

12. The position detection method of claim 11, wherein the step of establishing the correspondence relationship further comprises the steps of:
providing a plurality of sample points, each situated at a sample position on the planar object;
capturing a sample positional image of the sample point by each image capturing unit, wherein the sample positional image records a correspondence relationship between the sample position and a surface position of the planar object; and
recording the sample point, the sample position, and the sample positional image to produce the correspondence relationship.

13. The position detection method of claim 12, wherein the step of calibrating the positional image according to the correspondence relationship further comprises the steps of:
locating at least one sample point closest to the particular position of the object; and
calibrating the positional image according to the sample position and the sample positional image of the sample point closest to the particular position.

14. The position detection method of claim 13, wherein the particular position of the object is determined by each calibrated positional image.

15. The position detection method of claim 10, wherein the image capturing unit starts capturing the positional images if there is an image change on the planar object.

16. The position detection method of claim 10, wherein the image capturing unit captures the positional image periodically within a specific cycle, such that the particular position of the object is determined by the difference between the positional images of the most recently captured positional image and the positional image captured in the previous cycle.

17. The position detection method of claim 10, wherein the planar object is a display screen.

18. The position detection method of claim 10, wherein the image capturing unit is a complementary metal oxide semiconductor (CMOS) sensor, a digital camera, or a combination of the two.
